(19) United States
(12) Patent Application Publication
(10) Pub. No.: US 2019/0073972 A1
(43) Pub. Date: Mar. 7, 2019

(54) DRIVING METHOD FOR DISPLAY PANEL, DRIVING DEVICE FOR DISPLAY PANEL AND DISPLAY PANEL

(71) Applicants: BOE TECHNOLOGY GROUP CO., LTD., Beijing (CN); CHONGQING BOE OPTOELECTRONICS TECHNOLOGY CO., LTD., Chongqing (CN)

(72) Inventors: Xianyong GAO, Beijing (CN); Shuai HOU, Beijing (CN); Lijun XIAO, Beijing (CN); Xu LU, Beijing (CN); Siqing FU, Beijing (CN); Bo XU, Beijing (CN); Lisheng LIANG, Beijing (CN); Qiang YU, Beijing (CN); Xiaojun ZUO, Beijing (CN); Shuai CHEN, Beijing (CN); Xiuzhu TANG, Beijing (CN); Fei SHANG, Beijing (CN)

(21) Appl. No.: 15/767,201

(22) PCT Filed: Oct. 17, 2017
(86) PCT No.: PCT/CN2017/106528

§ 371 Date: Apr. 10, 2018

(30) Foreign Application Priority Data
Apr. 25, 2017 (CN) 201710277671.6

(51) Int. Cl. G09G 3/36; G06F 3/14; G09G 5/391; G09G 3/3225

(52) U.S. Cl. CPC G09G 3/3648; G06F 3/1431; G09G 2340/0407; G09G 3/3225; G09G 5/391

(57) ABSTRACT

A driving method for a display panel, a driving device for a display panel and a display panel in the field of display technology are disclosed. The driving method for a display panel, after the display panel is powered on and before its boot is formally completed, includes steps of: obtaining a first resolution of a to-be-displayed picture and/or text for a turn-on welcome tableau and a second resolution of a display screen, respectively, reconstructing the to-be-displayed picture and/or text according to the second resolution of the display screen, such that the resolution of the reconstructed to-be-displayed picture and/or text is adapted to the second resolution of the display screen, and transferring the reconstructed to-be-displayed picture and/or text to the display screen for display.

### RELATED APPLICATION

The present application is the U.S. national phase entry of PCT/CN2017/106528, with an international filing date of Oct. 17, 2017, which claims the benefit of Chinese Patent Application No. 201710277671.6, filed on Apr. 25, 2017, the entire disclosures of which are incorporated herein by reference.

### TECHNICAL FIELD

The disclosure belongs to the field of display technology, and in particular, relates to a driving method for a display panel, a driving device for a display panel and a display panel.

### BACKGROUND

In recent years, with the development of the display panel technology, the physical resolution of a tablet display (e.g., a liquid crystal display, LCD for short) such as a notebook is higher and higher, the accuracy of the display is higher and higher, and the speed of renewal is also faster and faster. However, in view of the cost and the development cycle, the update of the front-end system lags far behind that of the physical resolution of the display screen. For example, generally, only simple firmware information containing the most basic input output information required for system running is built in the system BIOS (Basic Input Output System), e.g., the manufacturer's trademark and some tips of the vendor system, etc., so as to keep small storage information to ensure a high driving efficiency. With respect to the situation in which the resolution of the front-end system firmware information does not match the physical resolution of the back-end display screen, how to solve the phenomenon of image blurring at the time of turn-on or restart has become a technical problem to be solved urgently at present.

### SUMMARY

At least one embodiment of the disclosure provides a driving method for a display panel, which, after the display panel is powered on and before its boot is formally completed, comprises steps of: obtaining a first resolution of a to-be-displayed picture and/or text for a turn-on welcome tableau and a second resolution of a display screen, respectively, reconstructing the to-be-displayed picture and/or text according to the second resolution of the display screen, such that the resolution of the reconstructed to-be-displayed picture and/or text is adapted to the second resolution of the display screen, and transferring the reconstructed to-be-displayed picture and/or text to the display screen for display.

In one example, the reconstructing the to-be-displayed picture and/or text according to the second resolution of the display screen comprises the steps of: extracting the contour information of the to-be-displayed picture and/or text, performing module matching or feature point matching on the to-be-displayed picture and/or text, and performing interpolation processing on the to-be-displayed picture and/or text according to the ratio of the second resolution of the display screen to the first resolution of the to-be-displayed picture and/or text.

In one example, after the interpolation processing is performed on the to-be-displayed picture and/or text, smoothing processing is then performed.

In one example, the second resolution of the display screen is the physical resolution of the display screen, and the first resolution of the to-be-displayed picture and/or text is less than the second resolution of the display screen.

In one example, the to-be-displayed picture and/or text is set and stored in advance.

In one example, the to-be-displayed picture and/or text comprises the manufacturer name, the boot information prompt or the user self-set display information, of the display panel.

There is further provided a driving device for a display panel, which comprises an Obtainer, a Reconstructor and a Transferrer, wherein

the Obtainer is configured to obtain a first resolution of a to-be-displayed picture and/or text for a turn-on welcome tableau and a second resolution of a display screen, respectively, the Reconstructor is configured to reconstruct the to-be-displayed picture and/or text according to the second resolution of the display screen, such that the resolution of the reconstructed to-be-displayed picture and/or text is adapted to the second resolution of the display screen, and the Transferrer transfers the reconstructed to-be-displayed picture and/or text to the display screen for display.

In one example, the Reconstructor comprises a Contour extractor, an Image matcher and an Interpolator, wherein the Contour extractor is configured to extract the contour information of the to-be-displayed picture and/or text, the Image matcher is configured to perform module matching or feature point matching on the to-be-displayed picture and/or text, and the Interpolator is configured to perform interpolation processing on the to-be-displayed picture and/or text according to the ratio of the second resolution of the display screen to the first resolution of the to-be-displayed picture and/or text.

In one example, the Reconstructor further comprises a Smoother for performing smoothing processing after the interpolation processing is performed on the to-be-displayed picture and/or text.

In one example, the second resolution of the display screen is the physical resolution of the display screen, and the first resolution of the to-be-displayed picture and/or text is less than the second resolution of the display screen.

In one example, there is further comprised an Image buffer for setting and storing the to-be-displayed picture and/or text in advance.

In one example, the to-be-displayed picture and/or text comprises the manufacturer name, the boot information prompt or the user self-set display information, of the display panel.

Therein, the display screen is a liquid crystal display screen or an OLED display screen.

At least one embodiment of the disclosure further provides a display panel comprising the above mentioned driving device for a display panel.

### BRIEF DESCRIPTION OF THE DRAWINGS

FIG. 1 is a structure diagram of a display panel in the prior art.

FIG. 2 is a flow chart of a driving method for a display panel in embodiment One of the disclosure.

FIG. 3 is a specific flow chart of the reconstruction step in FIG. 2.

FIG. 4 is a structure diagram of a driving device for a display panel in embodiment Two of the disclosure.

FIG. 5 is a specific structure diagram of the Reconstructor in FIG. 4.

FIG. 6 is a structure diagram of another driving device for a display panel in embodiment Two of the disclosure.

### DETAILED DESCRIPTION

In the following, the driving method for a display panel, the driving device for a display panel and the display device of the disclosure will be further described in detail in conjunction with the drawings and the particular embodiments, to make the skilled in the art better understand the technical solution of the disclosure.

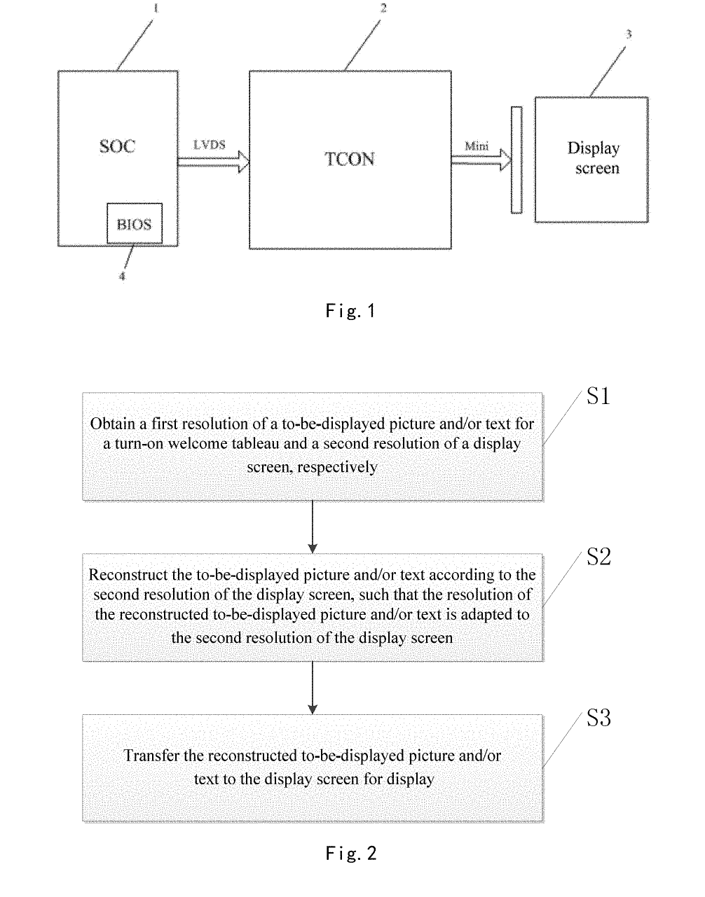

As shown in FIG. 1, after the system is started up and powered on or restarted, since at this point the SOC (System on Chip) system 1 (e.g., the windows system, etc.) is not booted completely, in order to display information such as the manufacturer product identification, information such as the product identification will be stored in the BIOS 4 in advance and directly sent to the TCON (Timer Control Register) 2 for processing before display.

In general, the resolution of the firmware information built in the system is far lower than the physical resolution of the actual display screen 3. Under the condition that the display information of the display screen 3 is provided by the BIOS 4, when a product of a panel factory matches that of a system factory in an actual application, especially when a high definition display screen 3 of the panel factory matches a low-end front-end system of the system factory, for example, in a whole machine system such as a notebook, a mobile phone, etc., if the resolution of related information stored in the BIOS 4 is lower than that of the display screen 3, then during display of the display screen 3 with a high resolution, a situation will inevitably take place in which the display tableau of the built-in information (e.g., the product identification) of the BIOS 4 is blurred at the time of turn-on or restart due to the resolution difference, giving rise to a situation in which a blurred product identification, blurred system prompt information, etc. occurs, causing that the tableau quality of the terminal integral unit product is reduced, and greatly affecting the customer's usage experience.

According to an embodiment of an aspect of the disclosure, there is provided a driving method for a display panel. With respect to that the system BIOS information displays on a high resolution display screen tableau information with the same resolution, the driving method for a display panel in this embodiment provides a solution with respect to that the display screen has a high resolution, whereas display of the built-in information of the front-end system has a low resolution, which effectively solves the problem that display of the system BIOS firmware information is blurred at the time of turn-on, shutdown or restart, solves the problem that the resolution of the firmware information of the system manufacturer required for display on the display panel does not match the display resolution of the display screen, and then achieves the effects of high-definition display and improving the quality of the whole machine.

As shown in FIG. 2, the driving method for a display panel, after the display panel is powered on and before its boot is formally completed, comprises the following steps.

At step S1), a first resolution of a to-be-displayed picture and/or text for a turn-on welcome tableau and a second resolution of a display screen are obtained respectively.

At this step, the second resolution of the display screen is the physical resolution of the display screen, and the first resolution of the to-be-displayed picture and/or text is less than the second resolution of the display screen. Since the resolution of the firmware information is not adapted to the display resolution of the display screen, the use experience in the process of power-on and boot of the display panel may be greatly improved by adjusting the resolution of the firmware information in advance. Here, the order in which the first resolution of the to-be-displayed picture and/or text for the turn-on welcome tableau is obtained and the second resolution of the display screen is obtained will not be defined.

Therein, the to-be-displayed picture and/or text is set and stored in an Image buffer. In fact, there may be multiple sources of the firmware information, for example, it is stored in the BIOS as in the prior art, and it may be processed as long as it is a picture or text before the official turn-on. The module matching process or the feature point matching process for reconstruction with an image to be displayed may be pre-stored in the front-end system or the TCON (Timer Control Register), as long as it can be ensured that the image to be displayed is effectively reconstructed before it enters the TCON. Here, the location for storage will not be defined.

The to-be-displayed picture and/or text comprises the manufacturer name, the boot information prompt or the user self-set display information, of the display panel. Of course, it may also comprise other pre-displayable information, which will not be limited here.

In a liquid crystal display panel, the TCON is generally employed as the center control board, which converts an LVDS (Low-Voltage Differential Signaling) image data input signal (an input signal contains three signals, an RGB data signal, a clock signal and a control signal) that is sent by a digital board and processed by a logic board into an LVDS signal that can drive the display screen, and then directly sends it to an LVDS receiver chip. The image data signal and the clock signal are converted into a control signal and a row and column driving signal that the display screen can identify by a processing & shift register, to control thin film transistors in the screen to operate so as to control the degree of twist of liquid crystal molecules, thereby displaying an image.

Before the TCON processes the information of the to-be-displayed picture and/or text outputted by the BIOS, the driving method for a display panel of the embodiment first converts the resolution of the information into one the same as the resolution of the display screen and then outputs it for display.

At step S2), the to-be-displayed picture and/or text is reconstructed according to the second resolution of the display screen, such that the resolution of the reconstructed to-be-displayed picture and/or text is adapted to the second resolution of the display screen.

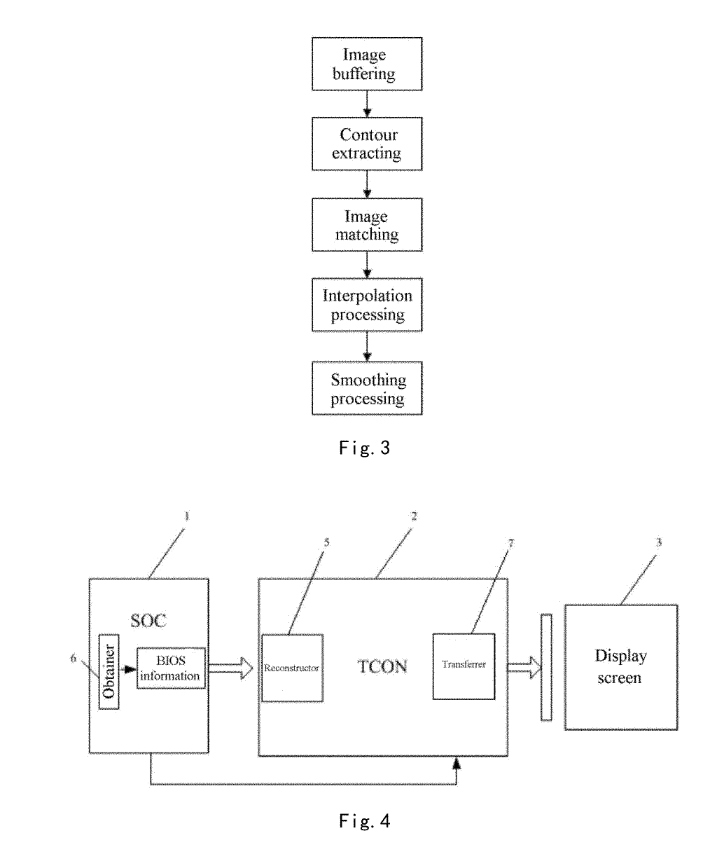

As shown in FIG. 3, at this reconstruction step, the reconstructing the to-be-displayed picture and/or text comprises the steps of: extracting the contour information of the to-be-displayed picture and/or text, performing module matching or feature point matching on the to-be-displayed picture and/or text, and performing interpolation processing on the to-be-displayed picture and/or text according to the ratio of the second resolution of the display screen to the first resolution of the to-be-displayed picture and/or text.

As described above, the to-be-displayed picture and/or text may be buffered in advance. After performing interpolation processing on the to-be-displayed picture and/or text, smoothing processing is then performed on it, in order to achieve the purpose of high-definition display and improve the quality of the whole machine.

The specific processing methods may be divided into multiple kinds, for example, image information may be reconstructed according to the feature point matching of an image (original image) to be displayed. Here, a feature point may be understood as feature information required for reconstructing an image. For example, to reconstruct a circle, necessary information such as the center of the circle, the radius, etc. is required. Generally, according to actual tableau information, it is necessary to determine different feature points, and then the reconstruction is performed. For example, for a logo [symbol] in the Hewlett-Packard system, the shape is a circle, there are letters HP inside the circle, the feature points of the circle comprise the position of the center and the length of the radius, and the feature points of the letters comprise information of the sizes and proportions of the horizontal, the verticals and the “semi-circle” in the letters HP, and the coordinate range they occupy as a whole. According to the feature point information, it may be possible to reconstruct the picture information of the logo [symbol] in the Hewlett-Packard system, essentially, complement picture pixels, to cause it to be adapted to the pixel resolution of the display screen.

In addition, a template may also be utilized for matching. The template for image information to be displayed may be stored in the TCON in advance, and when an original image is displayed, the information of the to-be-displayed picture and/or text is first stored in a buffer, and is matched with a predetermined template, and after the matching is successful, the template for the information of the to-be-displayed picture and/or text which has the same resolution as that of the display screen is displayed on the display screen. In general, the picture and/or text displayed at the time of turn-on is identical for each brand manufacturer, and therefore, it may be possible to store in a template library the version of a picture and/or text required for output by a potential manufacturer which has the same resolution as that of the display screen in advance, and match a tableau outputted by the SOC with a template in the template library at the time of turn-on.

The above specific steps of the reconstruction may reconstruct the system's built-in information to the same resolution as the display screen, and afterwards, it is displayed, which achieves the purpose of high-definition display and improves the quality of the whole machine. It will be easily understood that if it is a dynamically displayed tableau, then the reconstruction is performed as above for each frame. For example, 60 frames of tableaux is outputted per second, then the 60 frames are reconstructed as above and then displayed.

At step S3), the reconstructed to-be-displayed image and/or text is transferred to the display screen for display.

At this step, the reconstructed to-be-displayed picture and/or text is transferred to the display screen for display according to the process after the display panel is powered on and its boot is formally completed.

The driving method for a display panel is especially suitable for a situation in which the resolution of the firmware information of the system manufacturer required for display on the display screen does not match the display resolution of the display screen. By the driving method for a display panel, the built-in information of the system is reconstructed to the same resolution as the display screen and then displayed, which can effectively solve the problem that display of the system BIOS storage information on a high resolution display screen is blurred, achieve the purpose of high-definition display and improve the quality of the whole machine.

With respect to the problem of unclear display due to a low resolution of the built-in information when a low-end system is arranged in pairs with a high resolution LCD display screen, the driving method for a display panel proposes a method in which, according to the built-in information of the front-end system, the built-in information with the low resolution is first reconstructed to the same resolution as the display screen and then displayed, which achieves the purpose of high-definition display, improves the quality of the whole machine, and thereby improves the display effect of a terminal product.

With respect to the situation in which the resolution of the front-end system firmware information does not match the physical resolution of the back-end display screen, the driving method for a display panel effectively solves the problem of image blurring at the time of turn-on or restart.

According to an embodiment of another aspect of the disclosure, there is provided a driving device for a display panel which matches the driving method for a display panel in the above embodiment. With respect to that the system BIOS information displays on a high resolution display screen tableau information with the same resolution, the driving device for a display panel provides a solution with respect to that the display screen has a high resolution, whereas display of the built-in information of the front-end system has a low resolution, which effectively solves the problem that display of the system BIOS firmware information is blurred at the time of turn-on, shutdown or restart, solves the problem that the resolution of the firmware information of the system manufacturer required for display on the display panel does not match the display resolution of the display screen, and then achieves the effects of high-definition display and improving the quality of the whole machine.

As shown in FIG. 4, the driving device for a display panel in this embodiment comprises an Obtainer 6, a Reconstructor 5 and a Transferrer, wherein the Obtainer 6 is configured to obtain a first resolution of a to-be-displayed picture and/or text for a turn-on welcome tableau and a second resolution of a display screen 3, respectively, the Reconstructor 5 is configured to reconstruct the to-be-displayed picture and/or text according to the second resolution of the display screen 3, such that the resolution of the reconstructed to-be-displayed picture and/or text is adapted to the second resolution of the display screen 3, and

the Transferrer 7 transfers the reconstructed to-be-displayed picture and/or text to the display screen 3 for display.

The Obtainer 6 may obtain the resolution (essentially the data outputted by the SOC) of the display screen by information such as the EDID (Extended Display Identification Data), etc. The EDID is a VESA standard data format containing parameters of a related display and its performance therein, including supplier information, maximum image size, color settings, manufacturer pre-settings, frequency range limitation and strings of display name and serial number. The information is communicated to the system by the DDC (Display Data Channel), which is conducted between the display and a PC graphics adapter. The TCON is a controller contained in the display screen, the resolution is also known in advance, the data outputted by the SOC is processed, and the built-in information of the system is reconstructed to the same resolution as the display screen 3 and then displayed, which achieves the purpose of high-definition display and improves the quality of the whole machine.

Therein, the second resolution of the display screen 3 is the physical resolution of the display screen, and the first resolution of the to-be-displayed picture and/or text is less than the second resolution of the display screen 3. Since the resolution of the firmware information is not adapted to the display resolution of the display screen 3, the use experience in the process of power-on and boot of the display panel may be greatly improved by adjusting the resolution of the firmware information in advance. Here, the order in which the first resolution of the to-be-displayed picture and/or text for the turn-on welcome tableau is obtained and the second resolution of the display screen 3 is obtained will not be defined.

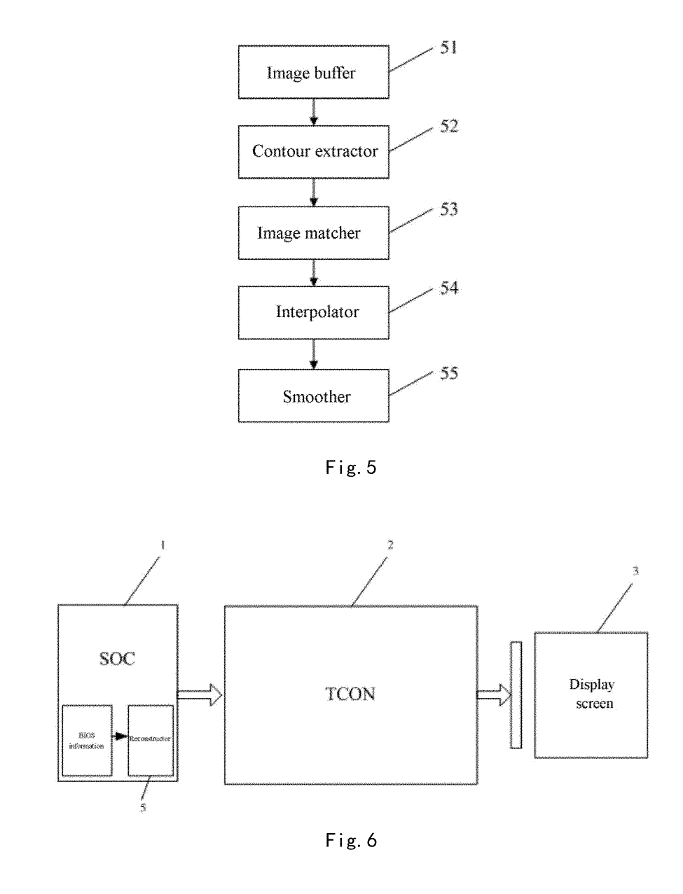

In one example, as shown in FIG. 5, the Reconstructor 5 comprises a Contour extractor 52, an Image matcher 53 and an Interpolator 54, wherein the Contour extractor 52 is configured to extract the contour information of the to-be-displayed picture and/or text, the Image matcher 53 is configured to perform module matching or feature point matching on the to-be-displayed picture and/or text, and the Interpolator 54 is configured to perform interpolation processing on the to-be-displayed picture and/or text according to the ratio of the second resolution of the display screen 3 to the first resolution of the to-be-displayed picture and/or text.

By the Reconstructor 5, the system's built-in information is reconstructed to the same resolution as the display screen 3 and then displayed, which achieves the purpose of high-definition display and improves the quality of the whole machine.

In one example, the Reconstructor 5 further comprises a Smoother 55 for performing smoothing processing after the interpolation processing is performed on the to-be-displayed picture and/or text, so as to achieve the purpose of high-definition display and improve the quality of the whole machine. In one example, the Reconstructor 5 is arranged in the TCON2, the information outputted by the BIOS4 is first processed by the TCON2, and two processing ways of feature point matching or template matching are provided, and the TCON2 converts the information into an image with the same resolution as the display screen 3 for output and display.

In one example, the driving device for a display panel further comprises an Image buffer 51 for setting and storing the to-be-displayed picture and/or text in advance. In fact, there may be multiple sources of the firmware information, for example, it is stored in the BIOS4 as in the prior art, and it may be processed as long as it is a picture or text before the official turn-on. The module matching process or the feature point matching template for reconstruction with an image to be displayed, as shown in FIG. 6 (the obtaining module and the transferring module are not shown in FIG. 6) and FIG. 4, may be pre-stored in the front-end SOC1 or the TCON2, as long as it can be ensured that the image to be displayed is effectively reconstructed before it enters the TCON2. Here, the location for storage will not be defined.

The to-be-displayed picture and/or text comprises the manufacturer name, the boot information prompt or the user self-set display information, of the display panel. Of course, it may also comprise other pre-displayable information, which will not be limited here.

With respect to the problem of unclear display due to a low resolution of the built-in information when a low-end system is arranged in pairs with a high resolution LCD display screen, the driving device for a display panel proposes a method in which, according to the built-in information of the front-end system, the built-in information with the low resolution is first reconstructed to the same resolution as the display screen and then displayed, which achieves the purpose of high-definition display, improves the quality of the whole machine, and thereby improves the display effect of a terminal product.

At present, the information that the BIOS can store is very limited, and it cannot store an image of high definition or 4K. However, one and the same system may be arranged in pairs with display screens with different resolutions, and to a certain degree, it is impossible for the system resolution to directly match the resolution of the display screen. However, by employing the driving method for a display panel and its corresponding driving device in the disclosure, the resolution may be increased by reconstructing the image information stored in the BIOS, causing that its resolution to be displayed is the same as the resolution of the display screen, and thereby enhancing the matching between the system and the display screen.

The driving device for a display panel is suitable for multiple display panels, for example, a liquid crystal display panel or an OLED display panel, and its scope of application is wide.

With respect to the situation in which the resolution of the front-end system firmware information does not match the physical resolution of the back-end display screen, the driving device for a display panel effectively solves the problem of image blurring at the time of turn-on or restart.

According to an embodiment of still another aspect of the disclosure, there is provided a display panel which comprises the driving device for a display panel in the above embodiments and is driven by employing the driving method for a display panel in the above embodiments.

In the display process of the display panel, the built-in information of the system is reconstructed to the same resolution as the display screen and then displayed after the display panel is powered on and its boot is formally completed, which achieves the purpose of high-definition display and improves the quality of the whole machine.

The display panel comprises a tablet computer, a notebook, a mobile phone, and a television, etc.

It may be appreciated that, the above embodiments are exemplary embodiments employed for the purpose of illustrating the principles of the disclosure, and however, the disclosure is not limited thereto. For those of ordinary skills in the art, various variations and improvements may be made without departing from the spirit and substance of the disclosure, and these variations and improvements are also construed as falling within the protection scope of the disclosure.

1. A driving method for a display panel, which, after the display panel is powered on and before its boot is formally completed, comprises steps of:
obtaining a first resolution of a to-be-displayed picture or text for a turn-on welcome tableau and a second resolution of a display screen, respectively,
reconstructing the to-be-displayed picture or text according to the second resolution of the display screen, such that the resolution of the reconstructed to-be-displayed picture or text is adapted to the second resolution of the display screen, and
transferring the reconstructed to-be-displayed picture or text to the display screen for display.

2. The driving method for a display panel as claimed in claim 1, wherein the reconstructing the to-be-displayed picture or text according to the second resolution of the display screen comprises the steps of:
extracting the contour information of the to-be-displayed picture or text,
performing module matching or feature point matching on the to-be-displayed picture or text, and
performing interpolation processing on the to-be-displayed picture or text according to the ratio of the second resolution of the display screen to the first resolution of the to-be-displayed picture or text.

3. The driving method for a display panel as claimed in claim 2, wherein after the interpolation processing is performed on the to-be-displayed picture or text, smoothing processing is then performed.

4. The driving method for a display panel as claimed in claim 1, wherein the second resolution of the display screen is the physical resolution of the display screen, and the first resolution of the to-be-displayed picture or text is less than the second resolution of the display screen.

5. The driving method for a display panel as claimed in claim 1, wherein the to-be-displayed picture or text is set and stored in advance.

6. The driving method for a display panel as claimed in claim 1, wherein the to-be-displayed picture or text comprises the manufacturer name, the boot information prompt or the user self-set display information, of the display panel.

7. A driving device for a display panel, comprising an Obtainer, a Reconstructor and a Transferrer, wherein
the Obtainer is configured to obtain a first resolution of a to-be-displayed picture or text for a turn-on welcome tableau and a second resolution of a display screen, respectively,
the Reconstructor is configured to reconstruct the to-be-displayed picture or text according to the second resolution of the display screen, such that the resolution of the reconstructed to-be-displayed picture or text is adapted to the second resolution of the display screen, and
the Transferrer transfers the reconstructed to-be-displayed picture or text to the display screen for display.

8. The driving device for a display panel as claimed in claim 7, wherein the Reconstructor comprises a Contour extractor, an Image matcher and an Interpolator, wherein
the Contour extractor is configured to extract the contour information of the to-be-displayed picture or text,
the Image matcher is configured to perform module matching or feature point matching on the to-be-displayed picture or text, and
the Interpolator is configured to perform interpolation processing on the to-be-displayed picture or text according to the ratio of the second resolution of the display screen to the first resolution of the to-be-displayed picture or text.

9. The driving device for a display panel as claimed in claim 8, wherein the Reconstructor further comprises a Smoother for performing smoothing processing after the interpolation processing is performed on the to-be-displayed picture or text.

10. The driving device for a display panel as claimed in claim 7, wherein the second resolution of the display screen is the physical resolution of the display screen, and the first resolution of the to-be-displayed picture or text is less than the second resolution of the display screen.

11. The driving device for a display panel as claimed in claim 7, further comprising an Image buffer for setting and storing the to-be-displayed picture or text in advance.

12. The driving device for a display panel as claimed in claim 7, wherein the to-be-displayed picture or text comprises the manufacturer name, the boot information prompt or the user self-set display information, of the display panel.

13. The driving device for a display panel as claimed in claim 7, wherein the display screen is a liquid crystal display screen or an OLED display screen.

14. A display panel comprising a driving device for a display panel as claimed in claim 7.

15. The display panel for a display panel as claimed in claim 14, wherein the Reconstructor comprises a Contour extractor, an Image matcher and an Interpolator, wherein the Contour extractor is configured to extract the contour information of the to-be-displayed picture or text,
the Image matcher is configured to perform module matching or feature point matching on the to-be-displayed picture or text, and
the Interpolator is configured to perform interpolation processing on the to-be-displayed picture or text according to the ratio of the second resolution of the display screen to the first resolution of the to-be-displayed picture or text.

16. The display panel for a display panel as claimed in claim 15, wherein the Reconstructor further comprises a Smoother for performing smoothing processing after the interpolation processing is performed on the to-be-displayed picture or text.

17. The display panel for a display panel as claimed in claim 14, wherein the second resolution of the display screen is the physical resolution of the display screen, and the first resolution of the to-be-displayed picture or text is less than the second resolution of the display screen.

18. The display panel for a display panel as claimed in claim 14, further comprising an Image buffer for setting and storing the to-be-displayed picture or text in advance.

19. The display panel for a display panel as claimed in claim 14, wherein the to-be-displayed picture or text comprises the manufacturer name, the boot information prompt or the user self-set display information, of the display panel.

20. The display panel for a display panel as claimed in claim 14, wherein the display screen is a liquid crystal display screen or an OLED display screen.
